(19) United States
(12) Patent Application Publication
(10) Pub. No.: US 2011/0179701 A1
(43) Pub. Date: Jul. 28, 2011

(54) Torrefaction of ligno-cellulosic biomasses and mixtures

(75) Inventor: Giuliano Grassi, Florence (IT)

(73) Assignee: G-ENERGY TECHNOLOGIES, LLC

(21) Appl. No.: 12/656,357

(22) Filed: Jan. 27, 2010

(51) Int. Cl. C10L 5/00; B01J 19/12

(52) U.S. Cl. 44/606; 204/157.15

(57) ABSTRACT

A method of treating a biomass material to produce a fuel comprising the steps of preheating the biomass material to a temperature ranging from about 80° C. to about 100° C. and drying the biomass material until the biomass material has a maximum water content of no more than 3%. Microwave radiation is applied to the pre-dried biomass material in a range of 3.0 to 8.0 GHz to heat the biomass material to a temperature ranging from about 230° C. to about 280° C. resulting in torrefaction of the biomass material. The biomass material is then cooled.

### RELATED APPLICATIONS

There are no related patent applications.

### STATEMENT REGARDING FEDERALLY SPONSORED RESEARCH OR DEVELOPMENT

Not applicable.

REFERENCE TO SEQUENCE LISTING, A TABLE, OR A COMPUTER PROGRAM LISTING COMPACT DISC APPENDIX

None.

### FIELD OF THE INVENTION

Torrefaction of biomass is a thermo-chemical treatment carried out at 200° C.-300° C., under anoxic conditions to produce a solid bio-fuel. The decomposition of hemicellulose in the biomass at this temperature range causes about 70% of the mass to be retained while approximately 90% of the initial biomass energy content is kept with the product having a low moisture content.

### BACKGROUND OF THE INVENTION

Torrefaction has been a well known process for more than a century, but presently a large and wide interest is emerging for up-grading the vast range of biomass resources of the planet. These biomass resources expected to provide a significant contribution to the world primary energy needs.

With the arrival on the market of low-cost petroleum/natural-gas and very-low cost coal the interest in torrefied wood disappeared in the latter half of the 20^{th} century for economic reasons.

However, with the emerging problems of environmental sustainability, security and diversification of energy supply, increasing demand and interest for renewable energy (in particular bio-energy that is expected to provide in a longer-term a large contribution to the world primary energy needs) and for mitigation of the CO₂ emission, torrefaction of ligno-cellulosic biomass has undergone a renewed interest. Raw biomass has a low energy density and generally contains too much moisture, is too hygroscopic, can rot during storage and is difficult to comminute into small particles. The fibrous structure and toughness of woody and grass biomass is created naturally through a complex structure of mainly three polymeric constituents; cellulose, hemicellulose and lignin. Cellulose fibres are responsible for the fibrous structure and anisotropic properties of the biomass and they are bound together through a matrix of mainly hemicellulose and to a lesser extent lignin. Sawdust and cutter shavings are a favored feedstock for pelletization and softwood is generally preferred over hardwood. Torrefaction technology when integrated with the agro-pellet technology appears to have great promise. Agro-pellets (produced by direct processing of any type of humid biomass or mixture) are physically very similar to conventional pellets for heating, except for the composition of micro-elements.

Because the current processing cost for torrefaction of agro-pellets is roughly the same as the long distance logistic-cost saving (transportation) due to the dramatic reduction (−30%) of the mass of the torrefied biomass, it is imperative that the energy used in torrefaction processing be significantly reduced to produce an economically feasible fuel. If such process cost reductions are achieved, the marketplace will give preference to the import of torrefied pellets economically produced due to their higher quality and lower transportation costs.

There are numerous uses of torrefied biomasses or mixtures, namely, such as co-firing in power plants of torrefied biomass with the mineral coal. Through torrefaction, the biomass becomes more like coal. Torrefied biomass pellets can be easily handled, are especially attractive rather than using raw biomass because the torrefied biomass pellets have higher heating value and are friable and can be blended, pulverized and co-fired with coal as the capital and operating costs for separate biomass fuel feed and firing systems are avoided. Well over half of the electric generation in the United States is derived from coal with more than two-thirds of the power plants using pulverized coal boilers. Because torrefied biomass is a high-quality, environmental friendly, solid biofuel and similar, from the operational point of view to coal, a high level of co-firing can be undertaken (50% up to complete substitution). Compared to the coal it replaces, the torrefied biomass reduces sulphur dioxide (SO₂), nitrogen oxides (NOx) and net greenhouse gas emission of CO₂. This offers considerable opportunity for world-wide CO₂ emission mitigation alone, keeping in mind that the substitution of 1 ton of agro-pellets saves ˜1.5 ton CO₂, while 1 ton of torrefied agro-pellets saves ˜1.9 ton CO₂. It is acknowledged that the initial torrefaction treatment has material losses and CO₂ emission, but these can be utilized in the process and can be taken into account in the evaluation of the specific total energy balance.

A generalized world-wide torrefied agro-pellet-coal co-firing activity (level of 20%) could provide a bioelectricity production equivalent to the power generation from about 200 nuclear power plants, with a decrease of about 1 billion tons of CO₂ emissions per year.

A number of patents disclose various torrefaction processes. U.S. Pat. No. 4,553,978 issued Nov. 19, 1985 discloses torrefaction of wood at a temperature ranging from 250° C. to 280° C. in an atmosphere of nitrogen at a slow temperature increases ranging from 2° C. or 4° C. per minute in a rotary kiln. After cooling the torrefied wood has a hygroscopicity of 3%.

U.S. Pat. No. 4,787,917 issued Nov. 29, 1988 is directed to the torrefaction of woody suckers having a diameter between 5 mm and 20 mm. After the suckers are harvested they are cut to a uniform length of between 10 mm and 25 mm. The cut sucker lengths are pre-dried to reduce the high quantity of water in the suckers which ranges between 40% to 60% at a temperature which is two to three times greater than that the temperature applied during the torrefaction process. This pre-drying reduces the water content of the suckers about 50%. The torrefaction is carried on at a temperature range of 250° C. to 280° C. for no more than 10 minutes resulting in a torrefied product having a water content being fixed at 3%.

U.S. Pat. No. 4,954,620 issued Sep. 4, 1990 discloses torrefaction of a ligno cellulose material, in oxygen free hot gases to preheat the material; softwood (conifer species) and hardwood, in a first zone from an ambient temperature up to 200° C. to eliminate humidity to not more than about 5%. The temperature is then rapidly raised to between 220° C. and 280° C. in a second zone by use of a gas burner. The temperature is then maintained at about the same temperature of the second zone in a third zone. The gas is permanently recycled to enable its temperature level to be accurately regulated. The mode of flow between the heated gases and the material is of the cross current type.

Japanese Patent Number JP11094463 issued Apr. 9, 1999 has a dry-air generator that releases dry air which absorbs and dissipates dispersed moisture. A dehydrator (2) compresses the raw material conveyed through a band conveyor (6) and press rollers (7), and disperses moisture to the raw material. The press rollers are oscillated by ultrasonic generators (8). It contains a microwave generator and induction heater for direct or indirect heating of raw material and evaporation of dispersed moisture.

Chinese Patent Number CN101100344 (publication date not available) is directed toward a method and apparatus for desiccation of sewage sludge to minimize the dangers generally associated with this material and ease its handling and disposal. The patent discloses heating sludge (76-78% water content) in first rotary kiln at 20-75° C., sending the heated sludge to a microwave processing device for 1-3 minutes, heating the cell-water in sludge and desiccating the same. The processed sludge is then sent into a mechanical dehydration device; stirred twice and the dehydrated sludge is placed into a stirring crusher to process crush-into-kernel treatment. The sludge is removed from a second rotary kiln through a sieve device, to produce sludge having a kernel-diameter of 1-8 mm and a water content below 40%.

U.S. Patent Publication 2009/0305355 published Dec. 10, 2009 discloses a method for the production of “syngas” from biomass wherein the “syngas” may subsequently be used for electrical generation or as feedstock for the production of “petrol, diesel, chemicals and plastics.” While noting that torrefaction processes were investigated, the publication discloses using “thermal pre-treatment pressurized [sic] steam and optionally microwaves” to liquify the biomass.

Somewhat similar to the '355 publication above, U.S. Patent Publication 2009/0151251 published Jun. 18, 2009 discloses methods and apparatuses for the production of “syngas” from “carbon-containing feedstock.” It includes a torrefaction step or alternatively, use of “microwave-assisted pyrolysis” in which the feedstock is subsequently fed through a heated reaction vessel, such as a steam reformer or partial-oxidation reactor, to form syngas.

Russian Patent RU2085084 issued Jul. 27, 1997 discloses a dehydrating apparatus for foodstuffs using alternating applications of heat and infrared radiation. In one stage, the spent steam air mixture from another stage is used with a forced feed of drying agent. An oscillating regime of drying with forced feed of drying agent is used at the second stage of dehydration. The density of the supplied heat flow is increased in comparison with the first stage at which there is used the steam-air mixture formed at the second stage.

Other methods of torrefaction have been, or are proposed as are shown in:

French Patent Number FR2624876 issued Jun. 29, 1989 sets forth a torrefaction process in continuous mode operation where the heating system for biomass is based on hot gas circulation (charged steam).

WO 2010 001137 published Jan. 7, 2010 discloses densifying biomass material and the microwave torrefaction of various biomasses at 2.45 GHz to obtain char and oil fuel products using preheating and torrefaction. Chemical additives such as sulphuric acid are added to improve the microwave efficiency for heating and breakdown of the densified biomass.

Several other patents propose as a heating system the use of micro-waves radiation devices. For example WO2008 134835 published Nov. 13, 2008 and BRP 10707567 issued Jun. 16, 2009 both apply micro-wave radiation having a frequency of 2.45 GHz which is the standard microwave frequency utilized for drying (water evaporation).

The present invention generally refers to a process for the conversion of a variety of ligno-cellulosic biomass products (pellets, chips, granules, powder and other small-size materials) by partial mild carbonization, into an high value bioenergy-commodity in particular direct conversion of an agro-pellet to a torrefied pellet.

A critical element for process optimization is the supply of controlled high rate heat inputs on the biomass.

Torrefaction under the present invention is of significant interest for the following reasons:
1) Increase (20%) of the heating-value of the processed feedstock;
2) Low energy loss during processing (˜10%), because the volatilized components have low heating values;
3) High material loss (˜30%) during the process, reducing the mass of the material to be transported;
4) Lower corrosion of the operating gas obtained by gasifiers (due to the volatilization of acetic acid);
5) Very low moisture content of 3% or less;
6) Biologically stable;
7) High friability (easy grinding);
8) Hydrophobic (easy storage).

Although the inventive process and typical apparatus may be applied to any ligno-cellulosic agro-forestry biomass feedstock or dedicated energy-crops, of any given dimensions, for economic, large-scale supply and for convenience of use, the preferred biomass products to be processed are the agro-forestry-pellets preferably of softwood and more preferably of conifers. These pellets have dimensions in the general range of 6-8 mm in diameter and up to 30 mm in length.

### SUMMARY OF THE INVENTION

The present invention is directed toward a process for manufacturing a “solid torrefied bio-fuel” from ligno-cellulose biomass pellets using a preheating step which heats the biomass in a range of 80° C. to 100° C. The biomass material is dried in a second step to obtain a maximum water content of 3% and torrefaction of the dried material is accomplished in a third step using microwave energy of 5.8 GHz to obtain a mild carbonization below 280° C. without affecting the cellulose and lignin components of the biomass. The torrefacted pellets are then cooled.

The invention is therefore a hybrid-system, where microwave energy is used in different phases, to accelerate the heating process. In particular microwave heating can be usefully applied to the first phase, namely: pre-heating of the biomass, the second phase drying and the third phase torrefaction.

It is an object of the invention to manufacture a pellet product which has been uniformly torrefied by the simultaneous or separate use of microwave radiation and thermal heating.

It is also an object of the invention to be able to produce a more homogeneous refined pellet product at a faster processing rate by the adoption of simultaneous heating on the inside and the surface (thermal heating and microwave heating) of pellets.

It is another objection of the invention to use two different microwave frequencies, one of which has a microwave frequency of 5.8 GHz which is particularly efficient for torrefaction of the dried biomass and for heat penetration into small sized biomass materials such as pellets.

It is yet another object of the invention to utilize a process which produces a torrefied fuel which consumes less energy during the torrefaction process making the torrefied fuel more economically feasible and with better energy balances.

It is still another object of the invention to produce a pellet based fuel which contains substantially most of the energy content (˜90%) of the starting material being processed.

It is further object of the invention to allow all types of biomasses/mixtures including soft woods such as conifers to be pelletized and further refined into “torrefied agro-pellets”.

These and other objects, advantages, and novel features of the present invention will become apparent when considered with the teachings contained in the detailed disclosure along with the accompanying drawings.

### BRIEF DESCRIPTION OF THE DRAWINGS

FIG. 1 is a schematic diagram representing the stages of the torrefaction process.

FIG. 2 is a schematic diagram of FIG. 1 showing the feedstock feed and the heat exchange between the stages: and

FIG. 3 is a cross section of a processing apparatus used to conduct the treatment and torrefaction of the biomass pellets in the various stages.

### DETAILED DESCRIPTION OF THE INVENTION

The present Invention relates to a new torrefaction (mild carbonization) process for the conversion of lingo-cellulosic biomass materials or mixtures pre-formed in a substantially uniform form (pellets, chips, granules, etc.) into a novel refined high value: “solid torrefied biofuel using a finely controlled processing-heating-combination using thermal and micro-waves at specific frequencies.

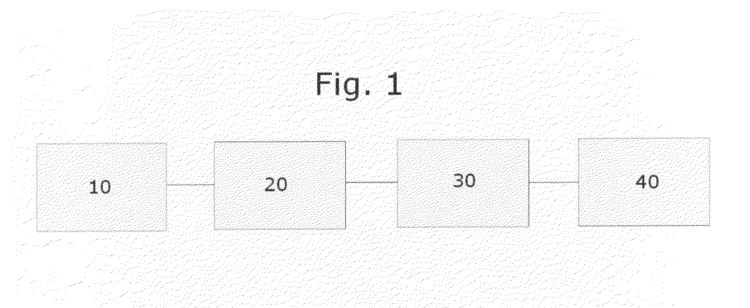

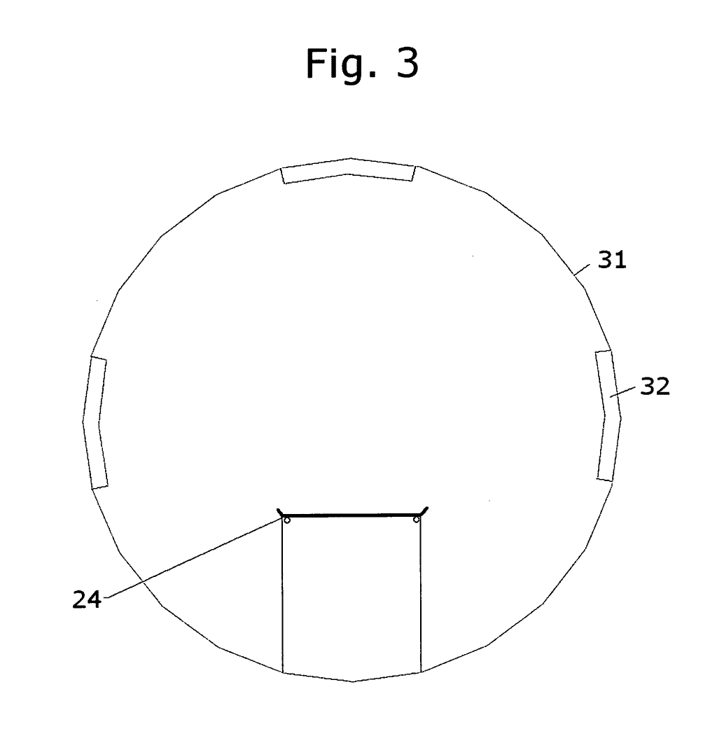

The preferred embodiments and best modes of the invention are shown in FIGS. 1 through 3. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

In addition, the originality of the invention relies also on the combined use of conventional heating and microwave radiation sources allowing for a better control and uniformity of the temperature of the material to be processed; an improved control of the temperature of the entire feedstock material (not only its skin temperature, but also its core temperature) as the same is actually crucial for improving the quality of the final torrefied product and also for avoiding the risk of exothermic reactions.

The use of microwave energy allows a volumetric heating that is effective in removing the “difficult” water (below 10%). In conventional heating during torrefaction, the average temperature of the workload asymptotically reaches the oven temperature, but with microwave heating the average temperature of the workload increases linearly for continuous power dissipation in the material.

The torrefied pellet fuel produced by the present inventive process is greatly different from the original biomass (biomass pellets) from charcoal and from the so called “brown-charcoal”, obtained by carbonization of wood at low-temperature. Physical characteristics of the invention are:
1) It is highly friable and can be milled easily;
2) It has very low hygroscopicity (about 3%);
3) It is stable (no biological degradation);
4) Its reactivity to combustion is high;
5) Its heating-value is high: ˜5,300 kcal/kg.

It appears that during torrefaction-treatment the cellulose component of the biomass is modified, without substantially affecting the cellulose and lignin components of biomass and that the same are relatively stable and not affected by the temperature level of the novel process.

The present invention is an improved torrefaction process that avoids the risk of triggering the exothermic pyrolysis process, which will lead to a completely different product in comparison with the “torrefied-biomass”, as is shown in the following Table 1:

TABLE 1

| | TORRIFIED | | | | |
|---|---|---|---|---|---|
| | BIOMASS | | CHARCOAL | BITUMINOUS | WOOD |
| FEEDSTOCK | PELLETS | | (for export) | COAL | PELLETS |
| Moisture % | 3% | (max) | 5% | ~0% | ~10% |
| Heating Value | ~5.300 | | 7.200 | 7.500 | ~4.000 |
| K_{cal}/Kg | | | | | |
| Sulphur Content % | ~0.05 | | ≧0.05% | 2%-10% | 0.05 |
| Ash Content % | ~5% | | 4% | 6%-20% | 0.1-1% |
| Energy Density | 0.40 | T_{OE}/m³ | 0.23 T_{OE}/m³ | 0.7 T_{OE}/m³ | 0.26 T_{OE}/m³ |
| T_{OE}/m³ | | | | | |
| Bulk density Kg/m³ | About 750 | (T. Pellets) | 560-708 | 700-800 | 750 |

During the present torrefaction treatment of ligno-cellulosic biomasses or mixtures (i.e. agro-pellets, etc.) formed acetic-acid is eliminated (by evaporation), reducing thus the negative effects of corrosion, which accompany the combustion and gasification of biomass.

It can be anticipated that torrefied biomass, produced under the following described method in practical terms, will be able to penetrate future sectors of the energy markets, with significant benefits occurring in regard to CO₂ mitigation, due to its high, attractive characteristics. The typical mass/energy balance of the biomass torrefaction process is shown below.

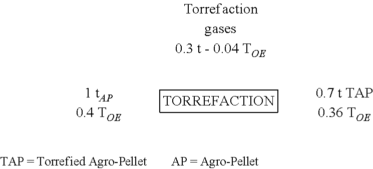

The process of the invention is basically a four step or stage process as shown in FIG. 1. The first stage as shown in block 10 (pre-heating) is used to heat the material preliminarily up to a temperature in the range of 80° C.-100° C. by means of conventional oven heating systems, which can also be combined with microwave sources operating at frequencies in the range at 2-8 GHz, preferably 2.45 GHz. This step can provide for the disposal of the water vapor which is produced during this stage of the process.

The second stage as shown in block 20 (drying) provides the drying of the material in order to obtain a maximum water content of 3%. This stage of the process is based on the use of conventional drying oven systems, which may be combined with microwave sources operating at frequencies in the range 2-8 GHz, and preferably around 2.45 GHz. If desired, microwaves may be the sole source of heating. During this stage water vapor is produced so that this stage is also equipped with a system for the recovery and possible energy utilization. The drying effect is completed in the temperature range of about 140° C. to about 200° C. It should be noted that a conventional oven has to be heated to a temperature substantially in excess of that required in the work load, while when using microwaves it is not necessary to reach a temperature greater than the target temperature.

Furthermore, the intervention time is lower with microwave heating thus temperature adjustments can be performed faster and safer (control loops higher quality control).

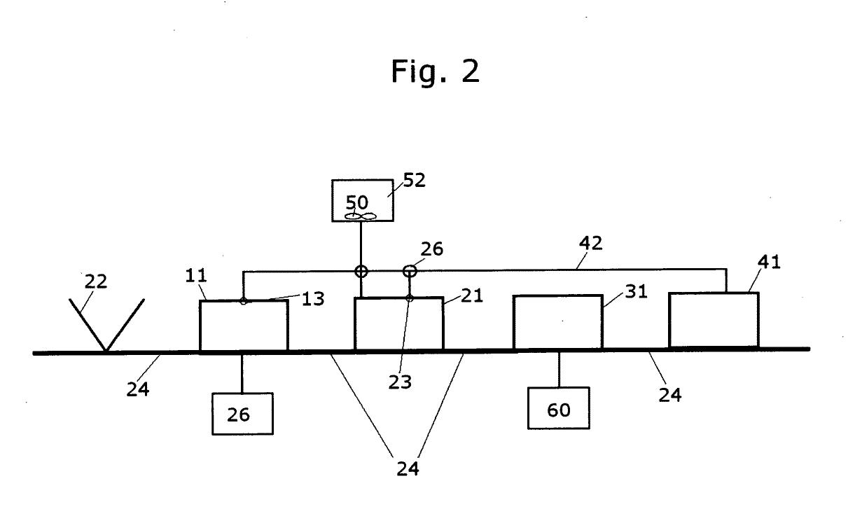

Depending on the material to be processed (and particularly its initial water content), these two first steps 10 and 20 constitute a pre-treatment unit to improve the productivity. Such pre-treatment is thus used to achieve standard water content in the material of no more than 3% before processing it in step 3. Alternately as shown in FIG. 2 super heated steam can be recycled from step 2 (block 20) back to stage 1 (block 10) for pre-drying the biomass. Alternately or dually the heated air from the cooling stage 4 (block 40) can be recycled back into the stage 1 (block 10) pre-drying stage. This can be accomplished by a heat exchanger, or chamber atmosphere blowers venting the heated air from the cooling chamber back to the pre-drying chamber.

In the pre-heating and drying phases, microwave power absorption largely depends on the dielectric losses of water. Water relaxation happens at very high microwave frequencies (the maximum dielectric losses occur at 18 GHz) thus the higher the frequency, greater is the power dissipation in wet materials. In steps 1 and 2 (pre-heating and drying) microwave power sources with a frequency of 2.45 are preferably utilized for reasons of economy.

Stage 3 as shown in block 30 (torrefaction) is the core stage of the process and is used for the torrefaction of the material using microwave-based torrefaction system. In this stage, the microwave source operating frequency is from 3.0 to 8.0 GHz and preferably 5.8 GHz for an optimized energy transfer to the dried pellet material and for uniform pellet torrefaction. In such way a better control and uniformity of the temperature of the material itself can be achieved. Consequently the insurgence of hot spots is avoided, eliminating the risk of triggering exothermic reactions.

The use of a neutral atmosphere as previously noted during the torrefaction process is used to reduce the risk of triggering uncontrollable exothermic reactions such as pyrolysis.

Based on a combination of well controlled and diversified heat inputs the adequate process temperature is between 230° C. and 280° C., but preferably around 270° C. Ligno-cellulosic biomass feed stocks or mixtures in appropriate form and size such as pellets, chips, granules, powder, etc are placed in neutral atmosphere (preferentially: CO₂, Argon, Nitrogen or combustion gases) that substantially (under the selected thermal conditions) are inert to combustion. If desired the biomass feed stock can be placed under vacuum during step 3.

Torrefaction is generally believed to occur below 280° C.; above 280° C. there is great risk of start-up of an uncontrollable pyrolysis process with great-loss of material and start-up of the carbonisation process.

The torrefaction stage of the process is based on the combined utilization of micro-wave radiation (preferentially 5.8 GHz) thermal inputs and also envisions the use of additional conventional thermal inputs (forced convection, thermal radiation and conduction (in inert atmosphere) on the material to be refined.

The micro-wave radiation with frequency of 5.8 GHz is in fact utilized, beyond the use of 2.45 GHz micro-waves radiation normally utilized for the earlier biomass drying. It should be noted that the 5.8 GHz microwaves radiation is more efficient than the 2.45 GHz radiation when the biomass moisture content is very low (torrefaction area). Therefore, to quickly reach a temperature level of 240° C. the use of a micro-wave radiation of a 5.8 GHz is very appropriate.

The fourth stage as indicated by block 40, in FIG. 1 provides for the cooling of the torrefied pellets in chamber 41 below 100° C. and the return of the heat to chamber 21 via conduit 42.

In operation the biomass pellets are fed into a hopper 22 in the pre-drying area onto a conveyor 24 which runs through chamber 21 where the pellets are heated and dried by a gas burner 26 which is used during start up of the process or to supplement heat returned from the cooling chamber 41. The supplemental heat circulates forced heated air through the pellet mass to dry the individual pellets. If desired the gas heating can be combined with one or more microwave generators operating at 2.45 GHz. The temperature in the chamber is preferably 80° C. to 100° C. If desired the conveyor can be a screw type of conveyer so that the pellets are constantly moved and brought into contact with the heated air. A heat exchanger 42 transmits heated air from the cooling chamber 41 back into the pre-drying chamber 21 to reduce energy costs. Selectively by means of valve 26, the heated air can be switched to chamber 11 when sensor 13 indicates the necessity of the same or sensor 23 indicates that the desired temperature has been reached.

The pre-dried pellets are carried by conveyor 24 into a moisture reduction chamber 21 where a series of microwave generators 32 dry the pellets so that their moisture content is 3% or less. The microwave generators 32 preferably operate at 2.45 MHz to heat the pellets and drive the moisture out of same with the temperature ranging in the chamber from 100° C. to 200° C. with the drying effect being completed in the temperature range of about 140° C. to about 200° C. If desired, moisture can be removed via exhaust fan 50 into condensation chamber 52. At up the 160° C. wood loses water and little else as most of its physical and mechanical properties remain intact. Above 180° C. the wood begins to brown and gives off moisture, carbon dioxide and acetic acid with some phenols. Microwave energy allows a volumetric heating that alone, or combined with conventional radiant surface-heating, is effective in removing the “difficult” water (below 10%). In conventional heating the average temperature of the workload asymptotically reaches the oven temperature but with microwave heating, the average temperature of the workload increases linearly, for continuous power dissipation in the material. It is also envisioned that superheated steam at atmospheric pressure can be used as the drying medium as drying times may be significantly reduced as compared to conventional hot air drying.

The dried pellets are then carried by the conveyor 24 into a sealed chamber 31 filled with a neutral atmosphere and heated by a plurality of microwave generators 32 which preferably operate at 5.8 MHz to heat the chamber in a range of 230° C. to 280° C., preferably 270° C. so that the pellets undergo torrefaction. The neutral gas is provided to chamber 31 from gas supply 60. Torrefaction consists in a fast uniform heating of all the biomass (or mixture) volume, avoiding that no portion of the feedstock being heated exceeds the 280° C., with a preferable temperature around 270° C. to avoid the presence of hot-spots (exceeding the temperature level of 280° C.) and the risk of triggering the exothermal uncontrolled pyrolysis process described above. It is important to operate in a neutral-inert atmosphere, with no oxygen, to limit the consequences of the exothermic reaction. The pellets are treated for a period ranging from about 10 to about 20 minutes depending upon the size of the pellets. For a size ø=6 mm of the pellets, the duration of “batch” continuous treatment at ˜270° C. is ˜20 min (for cycle).

In the present process the size of the pellets have a diameter 6-10 mm with a length less than 30 mm. It will be understood that the size of the pellets is uniform so that uniform heating to accomplish torrefaction within a designated period of time is accomplished The role of microwave radiation in the torrefaction is to accelerate the process operation and contribute to an improved, uniform temperature control of the feedstock being processed.

In the post-drying stages, from 200° C. up to the selected torrefaction temperatures, the cellulosic based material are “rather” transparent to microwaves and the microwave radiation sources with frequency of 2.45 GHz have very low efficiency. After wide testing of pellets of different origin, nature, an operational frequency of 5.8 GHz has been identified for use. This 5.8 GHz frequency has been selected for industrial ISM allocated use, and it is suitable to be generated by magnetron tubes, i.e. a known and mature technology.

Given the size of the treatment chamber, which is dictated by the industrial process (necessary yield, in tons/hour), the choice of an operation frequency of 5.8 GHz instead of 2.45 GHz greatly increases the mode density inside the microwave cavity, increasing the field uniformity and decreasing torrefaction time.

Furthermore with the same dissipated power, the internal electric field is lower at 5.8 GHz with respect to 2.45 GHz. This means a lower risk of voltage breakdown inside the torrefaction treatment chamber.

The process can be arranged either in batch operation mode or in continuous operation mode.

The batch operation mode is characterized by the arrangement of the steps 1-3 inside separate or the same process chamber. In this arrangement the temperature inside the chamber varies according to the on-going process by means of the use of combined thermal and microwave sources. The chamber will be loaded only partially and the material inside the chamber will be continuously mixed up to allow for more uniform and quick heating of the material.

The continuous operation mode envisions an apparatus constituted by a chain of different contiguous processing chambers. Each chamber is characterized by a specific set of chemical-physical parameters, energetic fluxes, temperature, etc., determined according to the function of the chamber (e.g. pre-heating, drying, torrefaction and cooling), and these remain constant throughout the process. The material can be transported along the chambers chain by means of a several well-known conveyor devices, such as: belt-type conveyor system, screw-type conveyor system, gravity-based conveyor system, etc.

While the invention envisions the use of microwave heating, the thermal sources employed in the process can be supplemented, for example: hot-gases fluxes, radiant panels (e.g. IR panels), and hot panels in direct contact with the material to be processed, or any other conventional heating systems as typically used in drying ovens. The microwave source(s) employed in the process operate at frequencies in the range of 2-8 GHz, and preferably around 5.8 GHz during the torrefaction step or stage, to improve the energy transfer to the material core and to enhance the uniformity of the field inside the chamber. Conventional, low-cost microwave sources operating at 2.45 GHz can be profitably used especially for the first two steps of the process (preheating and drying) when the water content of the material is still relatively high and consequently the energy transfer at this frequency is still good. The use of microwave sources operating at frequencies of 3.0 GHz to 8.0 GHz preferably around 5.8 GHz, during the torrefaction step specifically improves the energy transfer to the considered type of material (agro-pellets), improving the speed and uniformity of the heating of the material down to its core. Its use is more efficient in this stage of the process when the water content of material is already reduced to low values.

In microwave ovens about 95% of the microwave energy is converted into heat. About 85% of the electric energy is converted into microwave energy. The total efficiency (percentage of electric energy converted into heat) is eventually about 80%. Thus, the energy needed by using microwave heating is reduced by about ⅔ with respect to conventional ovens.

Additional products which can be produced after the biomass pellets have been torrefied are:

Bio-syn-gas for heavy engine operation, synthetic biofuel production and biochemicals production:

Gasification of torrefied biomass improves the quality of bio-syn-gas in comparison from syn-gas obtained by gasification of agro-pellets. In particular, the torrefaction process eliminates, by evaporation, the formed acetic acid, (origin of structural material corrosion) and part of condensable vapours (origin of tar deposits).

In addition, larger scale production of bio-hydrogen from torrefied biomass (i.e. agro-pellets) can be made by a 4-step process including:
1) Pelletization of agro-pellets from humid biomasses or mixtures;
2) Carbonization or torrefaction of agro-pellets;
3) Steam-reforming of “charcoal-agro-pellets” to obtain bio-syn-gas;
4) purification and CO—Catalytic-shifting of bio-syn-gas.

The yield can reach the following value: 55 Kg-H2/t AP with an anticipated cost of ˜2.000 [symbol] /t H₂, and a CO₂ saving of ˜8 t CO/t Bio-H₂ and considerable future benefits as “carbon-credits”.

Experimental trials of steam-reforming of “torrefied-agro-pellets” have shown an increase of the Bio-H₂ production to: 70 Kg-H2/t TAP

In this way, commercial production of Bio-H₂ from torrefied agro-pellets approaches full competitiveness in comparison of the conventional (most used) H₂—production process from of steam-reforming of natural-gas.

Production of synthetic bio-fuel (Fisher-Tropsch diesel fuel/DME/Jet Fuel/Bio-H₂) by advanced gasification of torrefied biomass:

In the E.U. and many other countries there exists an important production deficit of diesel-oil and jet fuel.

At present 5 tons of dry-biomass is needed for the production of 1 ton synthetic diesel-oil or jet fuel. The integration of the new agro-pellets technology, with the novel torrefaction technology will provide an important improvement of the process for the production of transport bio-fuels, and have a significant contribution on future large supply needs, because of the following:
1) improved economics,
2) large availability of use of different type of ligno-cellulosic biomasses or mixtures.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A method of treating a biomass material to produce a torrefied product comprising the steps of:
a. preheating the biomass material to a temperature ranging from about 80° C. to about 100° C.;
b. drying the biomass material until the biomass material has a maximum water content of no more than 3%;
c. applying microwave radiation to the dried biomass material in a range of 3.0 GHz to 8.0 GHz to transfer heating energy to said dried biomass material to reach a temperature ranging from about 230° C. to about 280° C. causing torrefaction of said biomass material; and
d. cooling the biomass material.

2. A method as claimed in claim 1 wherein said biomass material is ligno-cellulosic pellets.

3. A method as claimed in claim 2 wherein said pellet are wood pellets.

4. A method as claimed in claim 3 wherein said wood pellets are pine.

5. A method as claimed in claim 2 wherein said pellet has a diameter ranging from about 6 mm to about 10 mm and a length less than about 30 mm.

6. A method as claimed in claim 1 wherein said water content in step b. is about 3%.

7. A method as claimed in claim 1 wherein said microwave energy in step c) is applied to said biomass material at a frequency of about 5.8 GHz.

8. A method of treating a biomass material as claimed in claim 1 wherein said biomass material is continuously transported through at least steps a)-c).

9. A method of treating a biomass material wherein in step c) the material is heated to a temperature of about 270° C.

10. A method of treating biomass material as claimed in claim 1 wherein said biomass material is taken from a group consisting of pellets, chips, granules, and powder.

11. A method of treating biomass material as claimed in claim 1 wherein in step c) microwave energy is applied to said biomass material in a neutral atmosphere that is substantially inert to combustion.

12. A method of treating biomass material as claimed in claim 11 wherein said neutral atmosphere is taken from a group consisting of CO₂, Nitrogen, Argon, and combustion gases.

13. A method of treating biomass material as claimed in claim 1 wherein step c) is undertaken in a vacuum.

14. A method of treating biomass material as claimed in claim 1 wherein the surface and volume temperatures of the biomass are at substantially the same selected temperatures.

15. A method of treating biomass material as claimed in claim 1 wherein drying step b) is completed in a range of about 140° C. to about 200° C.

16. A method of treating biomass materials to produce a torrefied product using a microwave radiation source of 5.8 GHz for a period of time at a suitable temperature to achieve torrefaction.

17. A method of treating biomass materials as claimed in claim 16 wherein said biomass materials is predried prior to torrefaction of the biomass materials by exposure of said biomass materials to another heating means.

18. A method of treating biomass pellets by torrefaction to produce a fuel comprising the steps of:
a. preheating the biomass pellets to a temperature ranging from about 80° C. to about 100° C.;
b. drying the biomass pellets with microwave energy until the biomass pellets have a maximum water content of no more than 3%;
c. applying microwave radiation of about 5.8 GHz to the dried biomass pellets heating said biomass pellets until same reach a temperature above 260° C. but less than 280° C. allowing uniform torrefaction of said pellets; and
d. cooling the biomass pellets.

19. A method of treating biomass pellets as claimed in claim 18 wherein said biomass pellets are taken from a group consisting of pellets, chips, granules, and powder.

20. A method as claimed in claim 18 wherein said biomass pellets are ligno-cellulosic pellets.

21. A method of treating biomass pellets as claimed in claim 18 wherein said pellets are softwood.

22. A method of treating biomass pellets as claimed in claim 18 wherein said microwave energy in steps a. and b. is applied to said biomass pellets at a frequency of about 2.45 GHz.

23. A method of treating biomass material as claimed in claim 18 wherein in step c) microwave energy is applied to said biomass pellets in a neutral atmosphere that is substantially inert to combustion.

24. A method of treating biomass pellets as claimed in claim 23 wherein said neutral atmosphere is taken from a group consisting of CO₂, Nitrogen, Argon and combustion gases.

25. A method as claimed in claim 18 wherein said microwave energy in step c) is applied to said biomass pellets in a vacuum.

26. A method of treating biomass pellets as claimed in claim 18 wherein said temperature in step c is about 270° C.

27. A method of treating a biomass material in pellet form by torrefaction to produce a fuel having a higher energy content comprising the steps of:
a. preheating the biomass pellets having a size ranging from 6 mm to 10 mm and a length less than 30 mm with microwave energy of about 2.45 GHz to a temperature ranging from about 80° C. to about 100° C.;
b. drying the biomass pellets with microwave energy of about 2.45 GHz in a temperature range of about 100° C. to about 200° C. until the biomass pellets have a maximum water content of about 3%;
c. applying microwave radiation of about 5.8 GHz to the pre-dried biomass pellets to transfer energy to the biomass pellets and heat said biomass pellets to a temperature of about 270° C. so that said pellets are substantially uniformly torrefied; and
d. cooling the biomass pellets to allow handling.

28. A method as claimed in claim 27 wherein said microwave energy in step c) is applied to said biomass pellets in a vacuum.
